(19) United States
(12) Patent Application Publication
(10) Pub. No.: US 2006/0232714 A1
(43) Pub. Date: Oct. 19, 2006

(54) Method for storing real-time broadcasting in DMB terminal

(76) Inventors: Gun Sik Kim, Seoul (KR); Hyuk Soo Seo, Seoul (KR)

Correspondence Address: FENWICK & WEST LLP, SILICON VALLEY CENTER, 801 CALIFORNIA STREET, MOUNTAIN VIEW, CA, 94041, US

(21) Appl. No.: 11/395,847

(22) Filed: Mar. 30, 2006

(30) Foreign Application Priority Data
Apr. 13, 2005 (KR) 10-2005-0030788

(51) Int. Cl. H04N 5/63; H04N 5/64

(52) U.S. Cl. 348/730; 348/838

(57) ABSTRACT

Disclosed is a method for storing a real-time broadcasting while minimizing power consumption in a DMB terminal. The method comprises processes of receiving a broadcasting signal of a channel selected by a user of the terminal; determining whether there is a storing request for the received broadcasting signal; when there is the storing request, determining a storing mode state of the terminal; when the storing mode is set up as a low-power storing mode, storing the received broadcasting signal into an memory without playing the received broadcasting signal; and terminating the storing of the received broadcasting signal in accordance with a termination request.

### CROSS-REFERENCE TO RELATED APPLICATION

The present application is claiming priority of Korean Patent Application No. 10-2005-0030788, filed on Apr. 13, 2005, the content of which is herein incorporated by reference.

### BACKGROUND OF THE INVENTION

1. Field of the Invention

The present invention relates to a method of storing a real-time broadcasting while minimizing power consumption in a DMB terminal.

2. Description of the Related Art

A digital multimedia broadcasting (DMB) service is a service providing high-quality audio and video to a moving user, based on a digital technology. The DMB may be classified into a terrestrial DMB and a satellite DMB in accordance with transmission media for the service. In the terrestrial DMB, a VHF 12 channel is used to transmit a DMB signal. In the satellite DMB, a satellite is used to transmit the DMB signal and a gap filler, which is a transponder established on the ground, is used to transmit a broadcasting signal at a downtown, a mountainous region and the like in which reception conditions are poor.

A DMB terminal supporting the DMB service further requires a RF receiving section for receiving a broadcasting signal, a broadcasting signal demodulator and the like, in addition to RF transmitting/receiving sections and modulator/demodulator of the existing terminal. In addition, it requires high-performance audio/video decoding functions, a limited channel receiving function and a high-resolution display device of Quarter Video Graphics Array (QVGA) (320×240) or higher for watching the broadcasting.

Like this, the DMB terminal consumes greater power due to the additional devices and high-functioning supports, compared to the existing call-oriented terminal. For example, when an amount of a battery power is not much remained, there is no choice but to discontinue the broadcasting watching increasing the power consumption, if an user of the terminal wants to preserve some amount of battery power for carrying out the telephone function.

In addition, the existing DMB terminal having a mobile communication function cannot perform functions of voice communication, data transmission/reception or the like with the broadcasting watching at the same time. Further, since the broadcasting being received can be stored only while it is played, the power consumption is much due to the broadcasting play even though the user just desired to store the broadcasting and the terminal functions such as voice communication, short message service and the like cannot be used.

### SUMMARY OF THE INVENTION

Accordingly, the present invention has been made to solve the above-mentioned problems occurring in the prior art. The object of the present invention is to provide a method of storing a real-time broadcasting in a DMB terminal, which is capable of discontinuing play of a DMB signal when it is deficient in a remaining amount of a battery or a user of the terminal wants to use another function of the terminal during the play of the DMB signal, and immediately storing a digital-converted DMB signal in an internal or external memory, thereby minimizing power consumption and storing the real-time broadcasting.

In order to accomplish the object, there is provided a method of storing a real-time broadcasting in a DMB terminal comprising processes of: receiving a broadcasting signal of a channel selected by a user of the terminal; determining whether there is a storing request for the received broadcasting signal; when there is the storing request, determining a storing mode state of the terminal; when the storing mode is set up as a low-power storing mode, storing the received broadcasting signal into an memory without playing the received broadcasting signal; and terminating the storing of the received broadcasting signal in accordance with a termination request.

According to an embodiment of the invention, the method may further comprise processes of: when the storing mode is set up as a general storing mode, converting the received broadcasting signal into a digital signal, and then storing the converted signal in the memory with playing the converted signal at the same time; and when a remaining amount of a battery is lowered to a preset critical value during the storing of the converted signal in the general storing operation mode, changing the storing mode into the low-power storing mode and storing the DMB signal being received in the memory without playing the converted signal.

According to an embodiment of the invention, the method may further comprise a process of, when there is a request for a change into the low-power storing mode from the user of the terminal during the storing of the converted signal in the general storing operation mode, changing the storing mode into the low-power storing mode, and storing the converted signal in the memory without playing the converted signal.

According to an embodiment of the invention, the method may further comprise processes of: when there is no storing request for the received broadcasting signal, converting the received broadcasting signal into a digital signal, and then playing the converted signal in a general broadcasting play mode; and when a remaining amount of a battery is lowered to a preset critical value during the play of the converted signal in the general broadcasting play mode, changing the storing mode into the low-power storing mode, and storing the converted signal in the memory without playing the converted signal.

According to an embodiment of the invention, the method may further comprise a process of: when there is a request for a change into the low-power storing mode from the user of the terminal during the play of the converted signal in the general broadcasting play mode, changing the storing mode into the low-power storing mode, and storing the converted signal in the memory without playing the converted signal.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a DMB terminal to which a method of storing a real-time broadcasting according to an embodiment of the invention is applied; and

FIG. 2 is a flowchart showing a method of storing a real-time broadcasting in a DMB terminal according to an embodiment of the invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

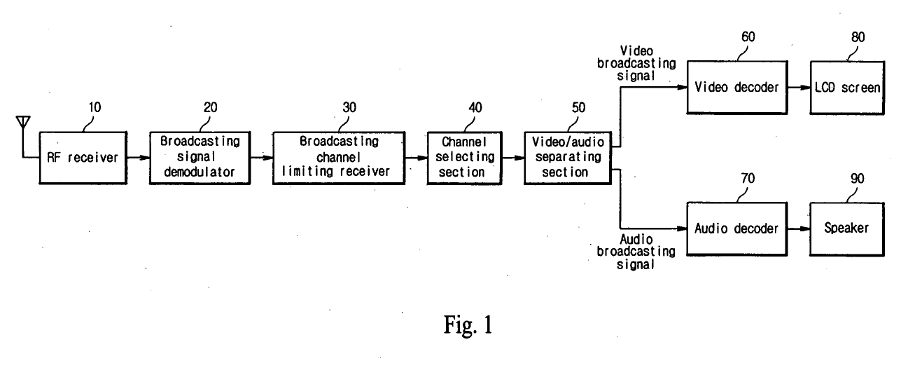

FIG. 1 is a block diagram of a DMB terminal to which a method of storing a real-time broadcasting according to an embodiment of the invention is applied. As shown in FIG. 1, the DMB terminal comprises a RF receiver 10, a broadcasting signal demodulator 20, a broadcasting channel limiting receiver 30, a channel selecting section 40, a video/audio separating section 50, a video decoder 60, an audio decoder 70, a LCD 80 and a speaker 90.

The RF receiver 10 receives a DMB signal.

The broadcasting channel limiting receiver 30 allows only an authorized user to receive a broadcasting of a charged channel.

The channel selecting section 40 selects a DMB channel which a user of the terminal desires to receive among the DMB signal received from the RF receiver 10.

The broadcasting signal demodulator 20 converts a DMB signal being received via the channel, which is selected by the channel selecting section 40 among DMB signals received via the RF receiver 10 into a digital signal.

The video/audio separating section 50 separates the broadcasting signal converted into digital type by the broadcasting signal demodulator 20 into a video broadcasting signal, and then an audio broadcasting signal and outputs the video broadcasting signal to the video decoder 60 and the audio broadcasting signal to the audio decoder 70.

The video decoder 60 decodes the video broadcasting signal transmitted from the video/audio separating section 50, and then displays the decoded video broadcasting signal on the LCD 80.

The audio decoder 70 converts the audio broadcasting signal transmitted from the video/audio separating section 50 into an analog signal, and then outputs the analog-converted audio broadcasting signal through the speaker 90.

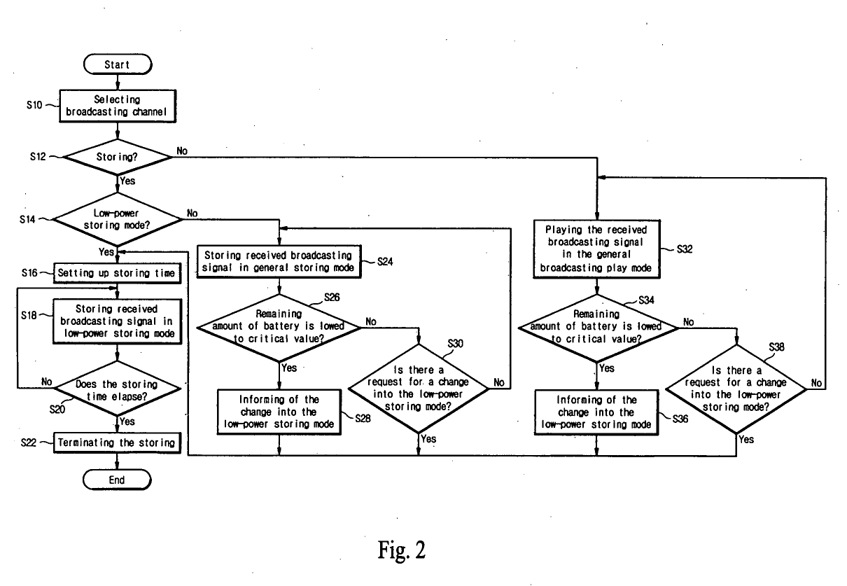

FIG. 2 is a flowchart showing a method of storing a real-time broadcasting in a DMB terminal according to an embodiment of the invention.

First, among the DMB signals being received through the RF receiver 10, a DMB signal selected by a user of the terminal is selectively received through the channel selecting section 40 (S10), and then it is determined whether there is a storing request for the selected DMB signal (S12).

As a result of the determination of S12, when there is the storing request for the selected DMB signal, it is determined whether a storing mode is set up as a low-power storing mode that is a mode for storing a digital-converted DMB signal into an internal or external memory without playing the selected DMB signal on the LCD (S14).

As a result of the determination of S14, if the storing mode is set up as the low-power storing mode, and if the user sets up a storing time for the selected DMB signal (S16), and the selected DMB signal is converted into a digital signal by the broadcasting signal demodulator 20 and then stored in the internal or external memory during the storing time (S18). In other words, in case of the low-power storing mode, the broadcasting signal, which is digital-converted by the broadcasting signal demodulator 20, is directly stored without the processes of the audio/video decoding and playing of the DMB signal. Accordingly, since it is omitted the processes that the converted signal is separated into the video and audio broadcasting signals and the separated signals are decoded in the video decoder 60 and the audio decoder 70 and played on the LCD 80 and the speaker 90, respectively, it is possible to save the powers required to decode the audio/video decoding and to drive the LCD and the speaker. Like this, since the audio decoder 70 and the LCD 80 do not output the selected DMB signal under idle state, the user can perform the functions such as voice communication, short message and the like during the storing of the selected DMB signal.

Then, when the storing time elapses (S20), it is terminated the storing of the DMB signal (S22).

In the mean time, as a result of the determination of S14, if the storing mode is set up as a general storing mode, the digital-converted DMB signal is stored in the internal or external memory with playing of the received DMB signal (S24). In other words, the DMB signal being received by selecting the channel selecting section 40 is converted into a digital signal through the broadcasting signal demodulator 20, and then the converted signal is separated into a video broadcasting signal and an audio broadcasting signal. The separated video and audio broadcasting signals are decoded in the video decoder 60 and the audio decoder 70 respectively, and then played through the LCD 80 and the speaker 90. At the same time, the broadcasting signal digital-converted by the broadcasting signal demodulator 20 is stored in the internal or external memory.

When a remaining amount of a terminal battery is lowered to a preset critical value during the storing of the DMB signal in the general storing operation mode (S26), the play of the DMB is discontinued and it is informed the user that the storing mode is changed into the low-power storing mode since there is deficient in the amount of the battery (S28). Then, the process proceeds to the S16 process in which the user sets up a storing time. After that, the DMB signal is stored in the low-power storing mode during the storing time set by the user. The critical value of the remaining amount of the battery in the process of S26 may be set up by the user.

In the mean time, when the remaining amount of the battery of the DMB terminal is not lowered to the critical value but there is a request for a change into the low-power storing mode from the user of the terminal (S30), the process proceeds to the S16 process in which the user sets up a storing time. After that, the DMB signal is stored in the low-power storing mode during the storing time set by the user. Like this, the user can change the general storing mode into the low-power storing mode if the user wants to use a function of the terminal, such as voice communication or short message.

As described above, when the storing mode is changed from the general storing mode to the low-power storing mode, the converted signal is stored in the internal or external memory without playing of the converted signal. Accordingly, it is possible to save the powers required to decode the audio/video decoding and to drive the LCD and the speaker for playing of the converted signal. The user of the terminal may watch the stored broadcasting in future.

In the mean time, as a result of the determination of S12, if there is no storing request for the DMB being received, the terminal operates in a general broadcasting play mode. Specifically, the DMB signal being received by selecting of the channel selecting section 40 is converted into a digital signal through the broadcasting signal demodulator 20, and then the converted signal is separated into a video broadcasting signal and an audio broadcasting signal. The separated video and audio broadcasting signals are decoded in the video decoder 60 and the audio decoder 70 respectively, and then played through the LCD 80 and the speaker 90 (S32).

When a remaining amount of the battery of the DMB terminal is lowered to a preset critical value during the play of the received DMB signal in the general broadcasting play mode (S34), the play of the DMB signal is discontinued, and it is informed the user that the storing mode is changed into the low-power storing mode since there is deficient in the amount of the battery (S36). Then, the process proceeds to the S16 process in which the user sets up a storing time. After that, the DMB signal is stored in accordance with the low-power storing mode during the storing time set up by the user. The critical value of the remaining amount of the battery in the process of S34 may be set up by the user.

In the mean time, when the remaining amount of the battery of the DMB terminal is not lowered to the critical value but there is a request for a change into the low-power storing mode from the user of the terminal (S38), the process proceeds to the S16 process in which the user sets up a storing time. After that, the DMB signal is stored in the low-power storing mode during the storing time. Like this, the user can change the general broadcasting play mode into the low-power storing mode if the user wants to use a function of the terminal, such as voice communication or short message.

As described above, if the general broadcasting reproduction mode is changed into the low-power storing mode, the user can store the DMB with real-time while using the terminal functions such as voice communication or short message and then watch the stored DMB in future.

As described above, according to the invention, when it is deficient in a remaining amount of a battery or a user of the terminal wants to use another function of the terminal on playing of the DMB being received, the play of the received DMB is discontinued and the digital-converted DMB signal is stored in an internal or external memory. Accordingly, the real-time broadcasting may be stored while the power consumption is minimized and the user can watch the stored broadcasting in future.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for storing a real-time broadcasting comprising processes of:
receiving a broadcasting signal of a channel selected by a user of the terminal;
determining whether there is a storing request for the received broadcasting signal;
when there is the storing request, determining a storing mode state of the terminal;
when the storing mode is set up as a low-power storing mode, storing the received broadcasting signal into an memory without playing the received broadcasting signal; and
terminating the storing of the received broadcasting signal in accordance with a termination request.

2. The method according to claim 1, wherein the process of storing the DMB signal in the low-power storing mode comprises steps of:
setting up a storing time by the user of the terminal; and
converting the received broadcasting signal into a digital signal during the set storing time and then storing the converted signal in the memory.

3. The method according to claim 1, further comprising processes of:
when the storing mode is set up as a general storing mode, converting the received broadcasting signal into a digital signal, and then storing the converted signal in the memory with playing the converted signal at the same time; and
when a remaining amount of a battery is lowered to a preset critical value during the storing of the converted signal in the general storing operation mode, changing the storing mode into the low-power storing mode and storing the DMB signal being received in the memory without playing the converted signal.

4. The method according to claim 3, wherein the process of changing the storing mode into the low-power storing mode and storing the converted signal comprises steps of:
setting up a storing time by the user of the terminal; and
converting the received broadcasting signal into a digital signal during the set storing time and then storing the converted signal in the memory.

5. The method according to claim 3, further comprising a process of, when there is a request for a change into the low-power storing mode from the user of the terminal during the storing of the converted signal in the general storing operation mode, changing the storing mode into the low-power storing mode, and storing the converted signal in the memory without playing the converted signal.

6. The method according to claim 5, wherein the process of changing the storing mode into the low-power storing mode in accordance with the request for the change and storing the converted signal comprises steps of:
setting up a storing time by the user of the terminal; and
converting the received broadcasting signal into a digital signal during the set storing time and then storing the converted signal in the memory.

7. The method according to claim 1, further comprising processes of:
when there is no storing request for the received broadcasting signal, converting the received broadcasting signal into a digital signal, and then playing the converted signal in a general broadcasting play mode; and
when a remaining amount of a battery is lowered to a preset critical value during the play of the converted signal in the general broadcasting play mode, changing the storing mode into the low-power storing mode, and storing the converted signal in the memory without playing the converted signal.

8. The method according to claim 7, wherein the process of changing the storing mode into the low-power storing mode and storing the converted signal in the memory comprises steps of:
setting up a storing time by the user of the terminal; and
converting the received broadcasting signal into a digital signal during the set storing time and then storing the converted signal in the memory.

9. The method according to claim 7, further comprising a process of: when there is a request for a change into the low-power storing mode from the user of the terminal during the play of the converted signal in the general broadcasting play mode, changing the storing mode into the low-power storing mode, and storing the converted signal in the memory without playing the converted signal.

10. The method according to claim 9, wherein the process of changing the storing mode into the low-power storing mode and storing the DMB signal comprises steps of:
setting up a storing time by the user of the terminal; and
converting the received broadcasting signal into a digital signal during the set storing time and then storing the converted signal in the memory.
